(19) United States
(12) Patent Application Publication
(10) Pub. No.: US 2016/0140892 A1
(43) Pub. Date: May 19, 2016

(54) METHOD OF DRIVING DISPLAY PANEL, DISPLAY PANEL DRIVING APPARATUS AND DISPLAY APPARATUS HAVING THE DISPLAY PANEL DRIVING APPARATUS

(71) Applicant: SAMSUNG DISPLAY CO., LTD., Yongin-si (KR)

(72) Inventors: Po-Yun PARK, Seoul (KR); Myeong-Su Kim, Hwaseong-si (KR); Sil-Yi Bang, Yongin-si (KR); Gwang-Soo Ahn, Suwon-si (KR); Jung-Hwan Cho, Asan-si (KR)

(21) Appl. No.: 14/939,682

(22) Filed: Nov. 12, 2015

(30) Foreign Application Priority Data
Nov. 13, 2014 (KR) 10-2014-0158237

(51) Int. Cl. G09G 3/20

(52) U.S. Cl. CPC G09G 3/2092; G09G 2310/0286; G09G 2310/0291; G09G 2310/08; G09G 2330/021; G09G 2330/06; G09G 2310/0254

(57) ABSTRACT

A display panel driving apparatus includes a timing controlling part, a data driving part and a gate driving part. The timing controlling part outputs a first line data of an image data, and determines whether the first line data and a second line data next to the first line data are the same. The data driving part outputs a first line data signal based on the first line data to a data line corresponding to a first line, and outputs the first line data signal based on the first line data to a data line corresponding to a second line, when the first line data and the second line data are the same.

### PRIORITY STATEMENT

This application claims priority from and the benefit of Korean Patent Application No. 10-2014-0158237, filed on Nov. 13, 2014, which is hereby incorporated by reference for all purposes as if fully set forth herein.

### BACKGROUND

1. Field

Exemplary embodiments relate to a method of driving a display panel, a display panel driving apparatus for performing the method, and a display apparatus having the display panel driving apparatus. More particularly, exemplary embodiments of the present inventive concept relate to a method of driving a display panel used in a display apparatus for displaying an image, a display panel driving apparatus for performing the method and a display apparatus having the display panel driving apparatus.

2. Discussion of the Background

A display apparatus such as a liquid crystal display apparatus typically includes a display panel and a display panel driving apparatus.

The display panel may include a gate line extending in a first direction, a data line extending in a second direction substantially perpendicular to the first direction, and a pixel defined by the gate line and the data line.

The display panel driving apparatus may include a gate driving part outputting a gate signal to the gate line, a data driving part outputting a data signal to the data line, and a timing controlling part controlling a timing of the gate driving part and the data driving part.

The data driving part may receive image data from the timing controlling part and may output the data signal.

Recently, the amount of image data output from the timing controlling part to the data driving part has increased, and thus, power consumption of the display apparatus and an electromagnetic interference (EMI) have also increased.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a method of driving a display panel capable of decreasing power consumption and an electromagnetic interference of a display apparatus.

Exemplary embodiments of the present inventive concept also provide a display panel driving apparatus for performing the above-mentioned method.

Exemplary embodiments of the present inventive concept also provide a display apparatus having the above-mentioned display panel driving apparatus.

Additional aspects will be set forth in the detailed description which follows, and, in part, will be apparent from the disclosure, or may be learned by practice of the inventive concept.

An exemplary embodiment of the present invention discloses a method of driving a display panel including outputting a first line data of an image data displayed on a display panel including a gate line and a data line, outputting a gate signal to the gate line and outputting a first line data signal based on the first line data to a data line corresponding to a first line, determining whether the first line data and a second line data next to the first line data are the same, and outputting the gate signal to the gate line and outputting the first line data signal based on the first line data to a data line corresponding to a second line next to the first line, when the first line data and the second line data are the same.

An exemplary embodiment of the present invention also discloses a display panel driving apparatus including a timing controlling part, a data driving part, and a gate driving part. The timing controlling part is configured to output a first line data of an image data displayed on a display panel including a gate line and a data line, and determine whether the first line data and a second line data next to the first line data are the same. The data driving part is configured to output a first line data signal based on the first line data to a data line corresponding to a first line, and output the first line data signal based on the first line data to a data line corresponding to a second line next to the first line, when the first line data and the second line data are the same. The gate driving part is configured to output a gate signal to the gate line.

An exemplary embodiment of the present invention also discloses a display apparatus including a display panel and a display panel driving apparatus. The display panel includes a gate line and a data line. The display panel driving apparatus a timing controlling part configured to output a first line data of an image data displayed on the display panel and determine whether the first line data and a second line data next to the first line data are the same, a data driving part configured to output a first line data signal based on the first line data to a data line corresponding to a first line and output the first line data signal based on the first line data to a data line corresponding to a second line next to the first line when the first line data and the second line data are the same, and a gate driving part configured to output a gate signal to the gate line.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a block diagram illustrating a display apparatus according to an exemplary embodiment of the present inventive concept.

FIG. 2 is a block diagram illustrating a data driving circuit part in a data driving part of FIG. 1.

FIG. 3 is a plan view illustrating a display panel displaying an image data of FIG.

FIG. 4 is a timing diagram illustrating the image data output from a timing controlling part to the data driving part of FIG. 1 and a waveform diagram illustrating a re-output signal of FIG. 1.

FIG. 5 is a flow chart illustrating a method of driving a display panel performed by a display panel driving apparatus of FIG. 1.

FIG. 6 is a block diagram illustrating a display apparatus according to an exemplary embodiment of the present inventive concept.

FIG. 7 is a block diagram illustrating a data driving circuit part in a data driving part of FIG. 6.

FIG. 8 is a timing diagram illustrating an image data output from a timing controlling part to the data driving part of FIG. 6 and waveforms diagram illustrating a re-output signal and a polarity inverting signal of FIG. 6.

FIG. 9 is a flow chart illustrating a method of driving a display panel performed by a display panel driving apparatus of FIG. 6.

FIG. 10 is a block diagram illustrating a display apparatus according to an exemplary embodiment of the present inventive concept.

FIG. 11 is a block diagram illustrating a data driving circuit part in a data driving part of FIG. 10.

FIG. 12 is a timing diagram illustrating an image data and a packet data output from a timing controlling part to the data driving part of FIG. 10.

FIG. 13 is a flow chart illustrating a method of driving a display panel performed by a display panel driving apparatus of FIG. 10.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

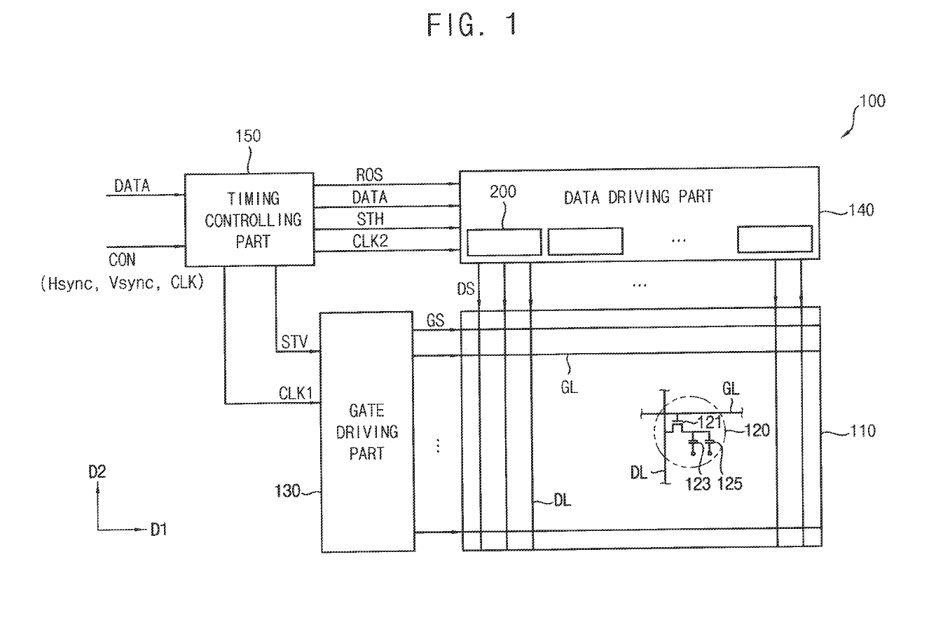

FIG. 1 is a block diagram illustrating a display apparatus according to an exemplary embodiment of the present inventive concept.

Referring to FIG. 1, the display apparatus 100 according to the present exemplary embodiment includes a display panel 110, a gate driving part 130, a data driving part 140, and a timing controlling part 150.

The display panel 110 receives a data signal DS based on an image data DATA provided from the timing controlling part 150 to display an image. For example, the image data DATA may be two-dimensional plane image data. Additionally or alternatively, the image data DATA may include a left-eye image data and a right-eye image data for displaying a three-dimensional stereoscopic image.

The display panel 110 includes gate lines GL, data lines DL, and a plurality of pixels 120. The gate lines GL extend in a first direction D1 and are arranged in a second direction D2 substantially perpendicular to the first direction D1. The data lines DL extend in the second direction D2 and are arranged in the first direction D1. Each of the pixels 120 includes a thin film transistor 121 electrically connected to the gate line GL and the data line DL, a liquid crystal capacitor 123, and a storage capacitor 125 connected to the thin film transistor 121.

The gate driving part 130, the data driving part 140, and the timing controlling part 150 may collectively be defined as a display panel driving apparatus driving the display panel 110.

The gate driving part 130 generates a gate signal GS in response to a gate start signal STV and a gate clock signal CLK1 provided from the timing controlling part 150, and outputs the gate signal GS to the gate line GL.

The data driving part 140 outputs a data signal DS to the data line DL in response to a data start signal STH and a data clock signal CLK2 provided from the timing controlling part 150. The data driving part 140 may include a plurality of data driving circuit parts 200 which receive the image data DATA and output the data signal DS.

The data driving part 140 may store a first line data, the first line data being data displayed on a first line of the display panel 110 among the image data DATA, and may output a first line data signal based on the first line data to a data line corresponding to the first line. The first line data signal may be included in the data signal. When the first line data and a second line data, the second line data being data displayed on a second line next to the first line of the display panel 110, are the same, the data driving part 140 may output the first line data signal based on the first line data to a data line corresponding to the second line in response to a re-output signal ROS provided from the timing controlling part 150. The first line may correspond to a first gate line among the gate lines GL and the second line may correspond to a second gate line next to the first gate line.

The timing controlling part 150 receives the image data DATA and a control signal CON from an external source. The control signal CON may include a horizontal synchronous signal Hsync, a vertical synchronous signal Vsync, and a clock signal CLK. The timing controlling part 150 generates the data start signal STH using the horizontal synchronous signal Hsync and outputs the data start signal STH to the data driving part 140. The timing controlling part 150 generates the gate start signal STV using the vertical synchronous signal Vsync and outputs the gate start signal STV to the gate driving part 130. The timing controlling part 150 generates the gate clock signal CLK1 and the data clock signal CLK2 using the clock signal CLK, outputs the gate clock signal CLK1 to the gate driving part 130, and outputs the data clock signal CLK2 to the data driving part 140.

The timing controlling part 150 may compare the first line data with the second lime data among the image data DATA. When the first line data and the second line data are the same, the timing controlling part 150 outputs, to the data driving part 140, the re-output signal ROS which instructs the output of the first line data signal based on the first line data to the data line corresponding to the second line. In this case, the timing controlling part 150 may not output the second line data to the data driving part 140.

When the first line data and the second line data are different, the timing controlling part 150 may output the second line data to the data driving part 140. In this case, the data driving part 140 stores the second line data, and outputs a second line data signal based on the second line data to the data line corresponding to the second line. The second line data signal may be included in the data signal.

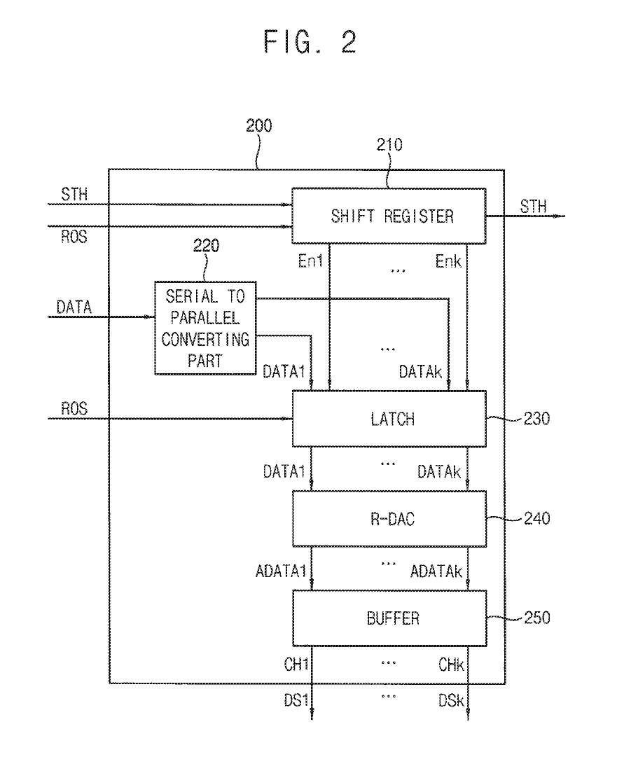

FIG. 2 is a block diagram illustrating the data driving circuit part 200 in the data driving part 140 of FIG. 1.

Referring to FIGS. 1 and 2, the data driving circuit part 200 includes a shift register 210, a serial to parallel converting part 220, a latch 230, a digital to analog converting part 240, and a buffer 250.

The serial to parallel converting part 220 receives the image data DATA, converts the image data DATA in parallel, and outputs parallel data DATA1, . . . , and DATAk.

The shift register 210 provides the parallel data DATA1, . . . , and DATAk to the latch 230 while the shift register 210 shifts the data start signal STH. When the shift register 210 receives the re-output signal ROS from the timing controlling part 150, the shift register 210 may not output enable signals En1, . . . , and Enk and may not store the parallel data DATA1, . . . , and DATAk in the latch 230.

The latch 230 stores the parallel data DATA1, . . . , and DATAk, and outputs the parallel data DATA1, . . . , and DATAk to the digital to analog converter 240. Here, when the parallel data DATA1, . . . , and DATAk are displayed on the first line of the display panel 110, the parallel data DATA1, . . . , and DATAk may be the first line data. When the parallel data DATA1, . . . , and DATAk are displayed on the second line of the display panel 110, the parallel data DATA1, . . . , and DATAk may be the second line data. Thus, the latch 230 may store the first line data and the second line data. The latch 230 may include a first storage part storing the first line data, and a second storage part storing the second line data. Thus, the latch 230 may store the second line data in the second storage part while the latch 230 outputs the first line data from the first storage part. In this case, although the first line data is output from the first storage part of the latch 230, the latch 230 may store the first line data.

When the timing controlling part 150 determines that the first line data and the second line data are the same and the latch 230 receives the re-output signal ROS from the timing controlling part 150, the latch 230 may not receive the second line data from the timing controlling part 150 and output the stored first line data to the data line corresponding to the second line.

The digital to analog converting part 240 receives the parallel data DATA1, . . . , and DATAk from the latch 230, converts the parallel data DATA1, . . . , and DATAk into analog data ADATA1, . . . , and ADATAk, and outputs the analog data ADATA1, . . . , and ADATAk to the buffer 250. The digital to analog converting part 240 may be a resistor digital to analog converting (R-DAC) part including resistors.

The buffer 250 outputs data signals DS1, . . . , and DSk to the data lines DL of the display panel 110 through channels CH1, . . . , and CHk. Here, the data signals DS1, . . . , and DSk may be included in the data signals DS of FIG. 1.

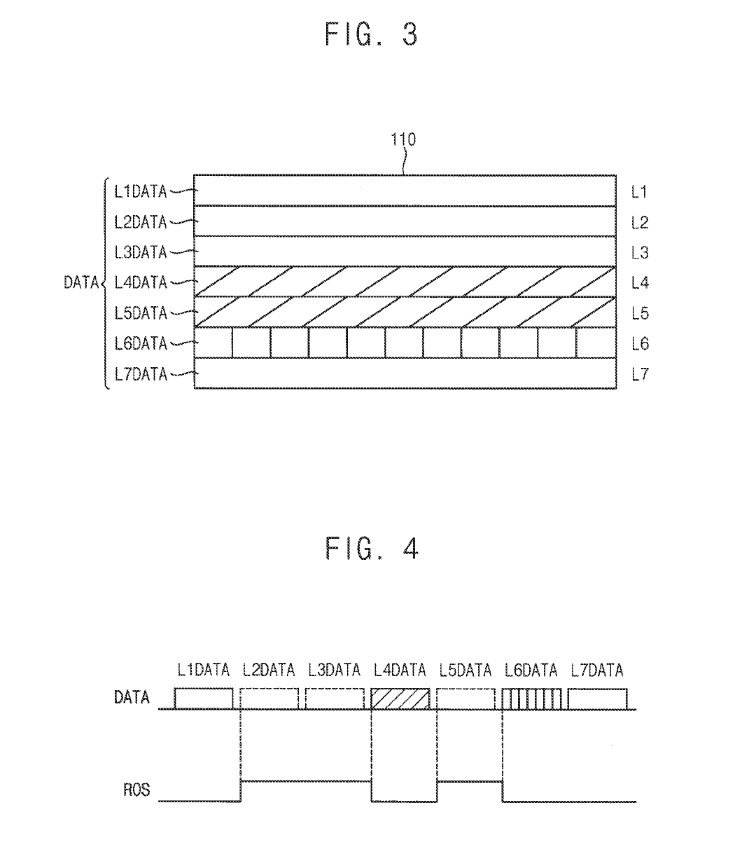

FIG. 3 is a plan view illustrating the display panel 110 displaying the image data DATA of FIG. 1.

Referring to FIGS. 1 and 3, the image data DATA may include a first line data L1DATA displayed on a first line L1 of the display panel 110, a second line data L2DATA displayed on a second line L2 of the display panel 110, a third line data L3DATA displayed on a third line L3 of the display panel 110, a fourth line data L4DATA displayed on a fourth line L4 of the display panel 110, a fifth line data L5DATA displayed on a fifth line L5 of the display panel 110, a sixth line data L6DATA displayed on a sixth line L6 of the display panel 110, and a seventh line data L7DATA displayed on a seventh line L7 of the display panel 110. For example, the first line data L1DATA, the second line data L2DATA and the third line data L3DATA may be the same. The third line data L3DATA and the fourth line data L4DATA may be different. The fourth line data L4DATA and the fifth line data L5DATA may be the same. The fifth line data L5DATA and the sixth line data L6DATA may be different. The sixth line data L6DATA and the seventh line data L7DATA may be different.

FIG. 4 is a timing diagram illustrating the image data DATA output from the timing controlling part 150 to the data driving part 140 of FIG. 1 and a waveform diagram illustrating the re-output signal ROS of FIG. 1.

Referring to FIGS. 1 to 4, the timing controlling part 150 outputs the first line data L1DATA to the data driving part 140. The data driving part 140 stores the first line data L1DATA, and outputs a first line data signal based on the first line data L1DATA to a data line corresponding to the first line L1.

Since the first line data L1DATA and the second line data L2DATA are the same, the timing controlling part 150 determines that the first line data L1DATA and the second line data L2DATA are the same. In this case, the timing controlling part 150 outputs the re-output signal ROS to the data driving part 140 or activates the re-output signal ROS output to the data driving part 140. The timing controlling part 150 does not output the second line data L2DATA to the data driving part 140.

The data driving part 140 outputs the first line data signal based on the stored first line data L1DATA to a data line corresponding to the second line L2.

Since the second line data L2DATA and the third line data L3DATA are the same, the timing controlling part 150 determines that the second line data L2DATA and the third line data L3DATA are the same. In this case, the timing controlling part 150 outputs the re-output signal ROS to the data driving part 140 or activates the re-output signal ROS output to the data driving part 140. The timing controlling part 150 does not output the third line data L3DATA to the data driving part 140.

The data driving part 140 outputs the first line data signal based on the first line data L1DATA which is the same as the second line data and stored in the data driving part to a data line corresponding to the third line L3.

Since the third line data L3DATA and the fourth line data L4DATA are different, the timing controlling part 150 determines that the third line data L3DATA and the fourth line data L4DATA are different. In this case, the timing controlling part 150 does not output the re-output signal ROS to the data driving part 140 or deactivates the re-output signal ROS output to the data driving part 140. The timing controlling part 150 outputs the fourth line data L4DATA to the data driving part 140.

The data driving part 140 stores the fourth line data L4DATA, and outputs a fourth line data signal based on the fourth line data L4DATA to a data line corresponding to the fourth line L4.

Since the fourth line data L4DATA and the fifth line data L5DATA are the same, the timing controlling part 150 determines that the fourth line data L4DATA and the fifth line data L5DATA are the same. In this case, the timing controlling part 150 outputs the re-output signal ROS to the data driving part 140 or activates the re-output signal ROS output to the data driving part 140. The timing controlling part 150 does not output the fifth line data L5DATA to the data driving part 140.

The data driving part 140 outputs the fourth line data signal based on the stored fourth line data L4DATA to a data line corresponding to the fifth line L5.

Since the fifth line data L5DATA and the sixth line data L6DATA are different, the timing controlling part 150 determines that the fifth line data L5DATA and the sixth line data L6DATA are different. In this case, the timing controlling part 150 does not output the re-output signal ROS to the data driving part 140 or deactivates the re-output signal ROS output to the data driving part 140. The timing controlling part 150 outputs the sixth line data L6DATA to the data driving part 140.

The data driving part 140 stores the sixth line data L6DATA, and outputs a sixth line data signal based on the sixth line data L6DATA to a data line corresponding to the sixth line L6.

Since the sixth line data L6DATA and the seventh line data L7DATA are different, the timing controlling part 150 determines that the sixth line data L6DATA and the seventh line data L7DATA are different. In this case, the timing controlling part 150 does not output the re-output signal ROS to the data driving part 140 or deactivates the re-output signal ROS output to the data driving part 140. The timing controlling part 150 outputs the seventh line data L7DATA to the data driving part 140.

The data driving part 140 stores the seventh line data L7DATA, and outputs a seventh line data signal based on the seventh line data L7DATA to a data line corresponding to the seventh line L7.

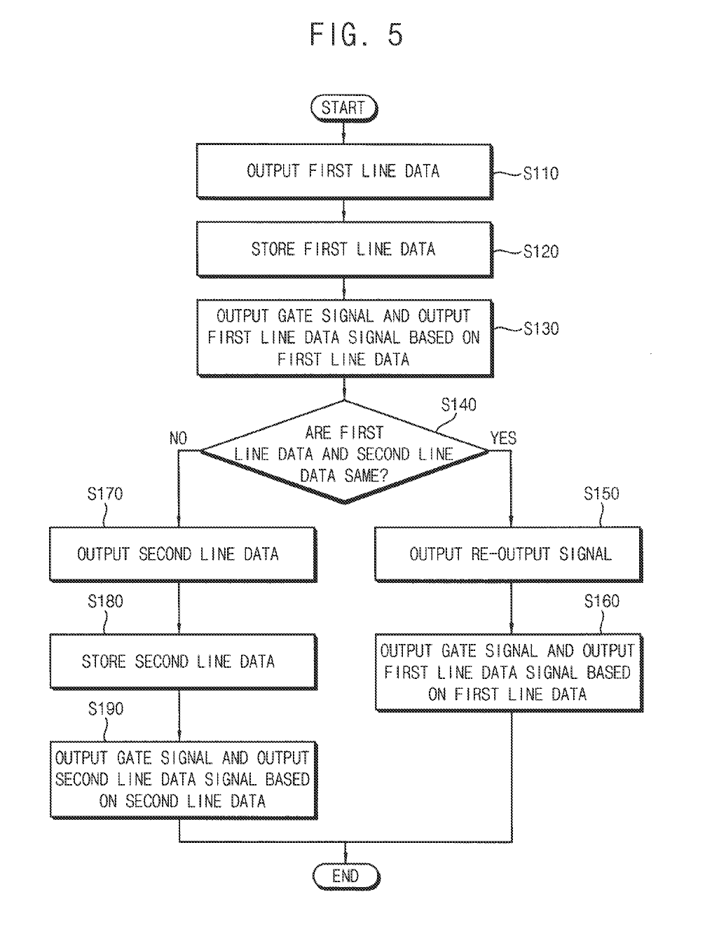

FIG. 5 is a flow chart illustrating a method of driving a display panel performed by the display panel driving apparatus of FIG. 1.

Referring to FIGS. 1 to 5, the first line data is output (step S110). Specifically, the timing controlling part 150 outputs the first line data displayed on the first line of the display panel 110 to the data driving part 140.

The first line data is stored (step S120). Specifically, the data driving part 140 stores the first line data provided from the timing controlling part 150. For example, the data driving part 140 may store the first line data in the latch 230.

The gate signal is output GS and the first line data signal based on the first line data is output (step S130). Specifically, the gate driving part 130 outputs the gate signal GS to the gate line GL. The data driving part 140 outputs the first line data signal based on the first line data to the data line corresponding to the first line.

The first line data is compared with the second line data to determine if the first line data and the second line data are the same (step S140). Specifically, the timing controlling part 150 compares the first line data with the second line data displayed on the second line of the display panel 110.

When the first line data and the second line data are the same, the re-output signal ROS is output (step S150). Specifically, the timing controlling part 150 outputs, to the data driving part 140, the re-output signal ROS which instructs the output of the first line data signal based on the first line data to the data line corresponding to the second line. In this case, the timing controlling part 150 may not output the second line data to the data driving part 140. The gate signal GS is output and the first line data signal based on the first line data is output (step S160). Specifically, the gate driving part 130 outputs the gate signal GS to the gate line GL. The data driving part 140 outputs the first line data signal based on the first line data to the data line corresponding to the second line.

Referring back to step S240, when the first line data and the second line data are different, the second line data is output (step S170). Specifically, the timing controlling part 150 outputs the second line data displayed on the second line of the display panel 110 to the data driving part 140.

The second line data is stored (step S180). Specifically, the data driving part 140 stores the second line data provided from the timing controlling part 150. For example, the data driving part 140 may store the second line data in the latch 230.

The gate signal GS is output and the second line data signal based on the second line data is output (step S190). Specifically, the gate driving part 130 outputs the gate signal GS to the gate line GL. The data driving part 140 outputs the second line data signal based on the second line data to the data line corresponding to the second line.

According to the present exemplary embodiment, since the second line data is not output from the timing controlling part 150 to the data driving part 140 when the first line data and the second line data are the same, a data communication amount between the data driving part 140 and the timing controlling part 150 may be decreased. Thus, power consumption of the display apparatus 100 may be decreased and an electromagnetic interference (EMI) due to a data communication may be decreased.

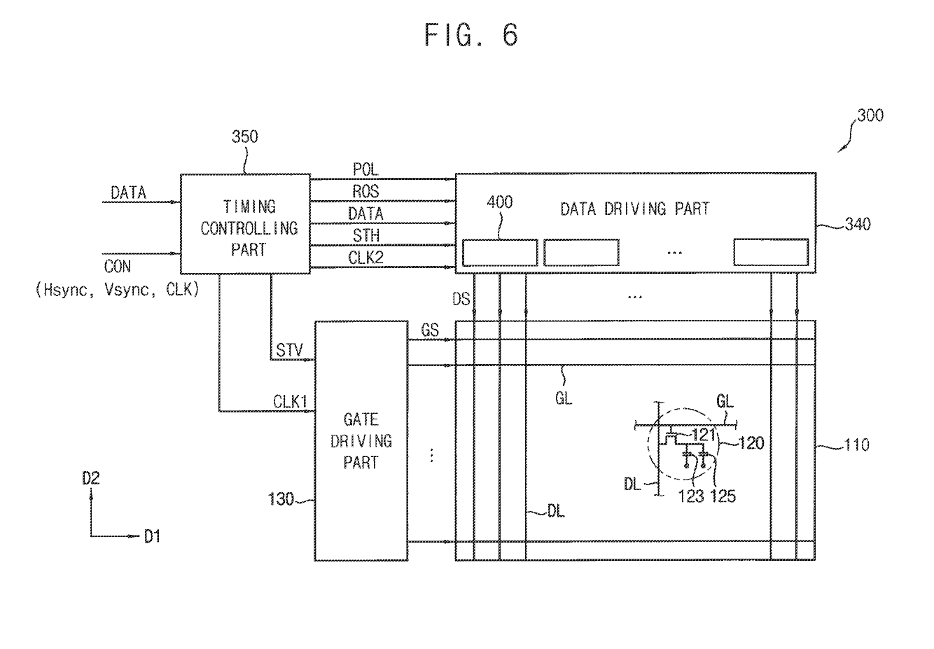

FIG. 6 is a block diagram illustrating a display apparatus according to an exemplary embodiment of the present inventive concept.

The display apparatus 300 according to the present exemplary embodiment is substantially the same as the display apparatus 100 according to the previous exemplary embodiment illustrated in FIG. 1 except for a data driving part 340 and a timing controlling part 350. Thus, the same reference numerals may be used to refer to same or like parts as those described in the previous exemplary embodiment and any further repetitive explanation concerning the above elements may be omitted.

Referring to FIG. 6, the display apparatus 300 according to the present exemplary embodiment includes the display panel 110, the gate driving part 130, the data driving part 340, and the timing controlling part 350.

The gate driving part 130, the data driving part 340, and the timing controlling part 350 may collectively be defined as a display panel driving apparatus driving the display panel 110.

The data driving part 340 outputs the data signal DS to the data line DL in response to the data start signal STH and the data clock signal CLK2 provided from the timing controlling part 350. The data driving part 340 may include a plurality of data driving circuit parts 400 which receive the image data DATA and output the data signal DS.

The data driving part 340 stores the first line data displayed on the first line of the display panel 110, among the image data DATA, and outputs the first line data signal based on the first line data to the data line corresponding to the first line. When the first line data and the second line data displayed on the second line next to the first line of the display panel 110 are the same, the data driving part 340 may output the first line data signal based on the first line data to the data line corresponding to the second line in response to the re-output signal ROS provided from the timing controlling part 350. Here, the first line may correspond to the first gate line among the gate lines GL and the second line may correspond to the second gate line next to the first gate line.

The data driving part 340 may invert polarities of the first line data signal and the second line data signal in a line unit of the first line and the second line according to a polarity inverting signal POL provided from the timing controlling part 350. Specifically, the data driving part 340 may invert polarities of the data signals DS every line according to the polarity inverting signal POL.

The timing controlling part 350 receives the image data DATA and the control signal CON from an external source. The control signal CON may include the horizontal synchronous signal Hsync, the vertical synchronous signal Vsync, and the clock signal CLK. The timing controlling part 350 generates the data start signal STH using the horizontal synchronous signal Hsync and outputs the data start signal STH to the data driving part 340. The timing controlling part 350 generates the gate start signal STV using the vertical synchronous signal Vsync and outputs the gate start signal STV to the gate driving part 130. The timing controlling part 350 generates the gate clock signal CLK1 and the data clock signal CLK2 using the clock signal CLK, outputs the gate clock signal CLK1 to the gate driving part 130, and outputs the data clock signal CLK2 to the data driving part 340. The timing controlling part 350 outputs the polarity inverting signal POL to the data driving part 340.

The timing controlling part 350 compares the first line data with the second lime data among the image data DATA. When the first line data and the second line data are the same, the timing controlling part 350 outputs, to the data driving part 340, the re-output signal ROS which instructs the output of the first line data signal based on the first line data to the data line corresponding to the second line. In this case, the timing controlling part 350 may not output the second line data to the data driving part 340.

When the first line data and the second line data are different, the timing controlling part 350 outputs the second line data to the data driving part 340. In this case, the data driving part 340 stores the second line data, and outputs a second line data signal based on the second line data to the data line corresponding to the second line.

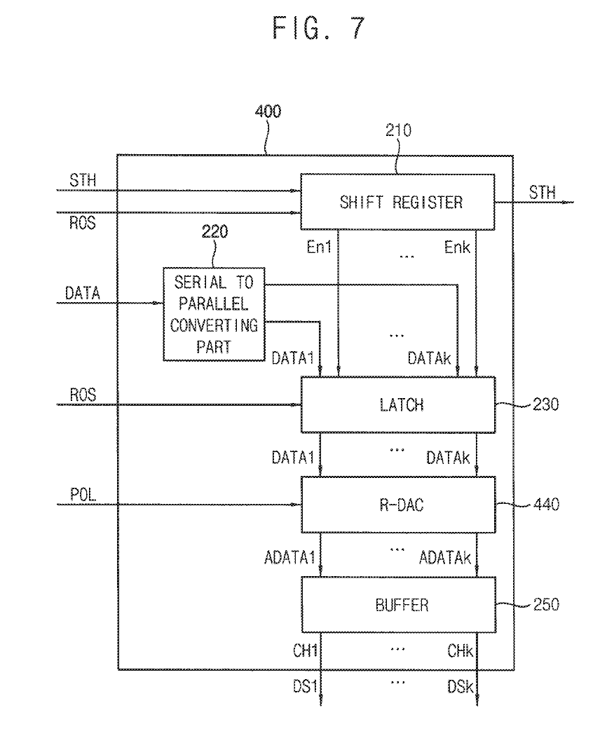

FIG. 7 is a block diagram illustrating the data driving circuit part 400 in the data driving part 340 of FIG. 6.

The data driving circuit part 400 according to the present exemplary embodiment is substantially the same as the data driving circuit part 200 according to the previous exemplary embodiment illustrated in FIG. 2 except for a digital to analog converting part 440. Thus, the same reference numerals may be used to refer to same or like parts as those described in the previous exemplary embodiment and any further repetitive explanations may be omitted.

Referring to FIGS. 6 and 7, the data driving circuit part 400 includes the shift register 210, the serial to parallel converting part 220, the latch 230, the digital to analog converting part 440, and the buffer 250.

The digital to analog converting part 440 receives the parallel data DATA1, . . . , and DATAk from the latch 230, converts the parallel data DATA1, . . . , and DATAk into the analog data ADATA1, . . . , and ADATAk, and outputs the analog data ADATA1, . . . , and ADATAk to the buffer 250. In this case, the digital to analog converting part 440 inverts polarities of the analog data ADATA1, . . . , and ADATAk in the line unit according to the polarity inverting signal POL provided from the timing controlling part 350. Thus, the polarities of the data signals DS output from the data driving part 340 may be inverted in the line unit. The digital to analog converting part 440 may be a resistor digital to analog converting part including resistors.

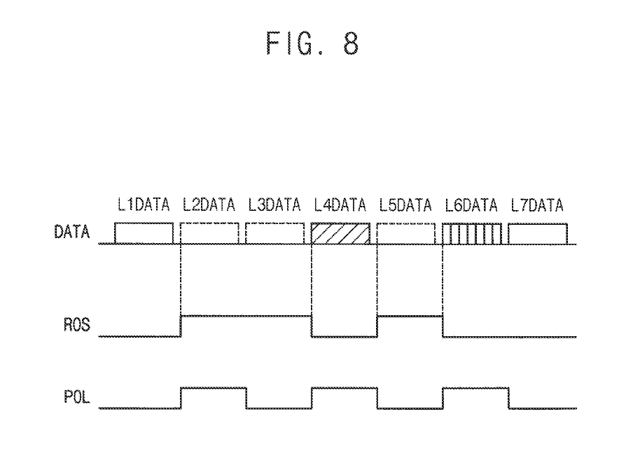

FIG. 8 is a timing diagram illustrating the image data DATA output from the timing controlling part 350 to the data driving part 340 of FIG. 6 and a waveforms diagram illustrating the re-output signal ROS and the polarity inverting signal POL of FIG. 6.

Referring to FIGS. 6 to 8, the image data DATA may be displayed on the display panel 110 as described in FIG. 3. Thus, the image data DATA may include the first line data L1DATA displayed on the first line L1 of the display panel 110, the second line data L2DATA displayed on the second line L2 of the display panel 110, the third line data L3DATA displayed on the third line L3 of the display panel 110, the fourth line data L4DATA displayed on the fourth line L4 of the display panel 110, the fifth line data L5DATA displayed on the fifth line L5 of the display panel 110, the sixth line data L6DATA displayed on the sixth line L6 of the display panel 110, and the seventh line data L7DATA displayed on the seventh line L7 of the display panel 110. For example, the first line data L1DATA, the second line data L2DATA and the third line data L3DATA may be the same. The third line data L3DATA and the fourth line data L4DATA may be different. The fourth line data L4DATA and the fifth line data L5DATA may be the same. The fifth line data L5DATA and the sixth line data L6DATA may be different. The sixth line data L6DATA and the seventh line data L7DATA may be different.

Since the first line data L1DATA, the second line data L2DATA and the third line data L3DATA are the same, the second line data L2DATA and the third line data L3DATA which are the same as a previous line data (in this case, the first line data L1DATA) may not be output from the timing controlling part 350 to the data driving part 340. In this case, the data driving part 340 may output the first line data signal based on the first line data L1DATA to the data line corresponding to the second line L2 and the data line corresponding to the third line L3.

Since the fourth line data L4DATA and the fifth line data L5DATA are the same, the fifth line data L5DATA, which is the same as a previous line data (in this case, fourth line data L4DATA), may not be output from the timing controlling part 350 to the data driving part 340. In this case, the data driving part 340 may output the fourth line data signal based on the fourth line data L4DATA to the data line corresponding to the fifth line L5.

The polarity inverting signal POL may be inverted in a line data unit of the first to seventh line data L1DATA, . . . , and L7DATA. The polarity inverting signal POL may invert the polarities of the first to seventh line data signals output based on the first to seventh line data L1DATA, . . . , and L7DATA, respectively, in the line unit.

For example, each of the first line data signal output based on the first line data L1DATA, the third line data signal output based on the third line data L3DATA, the fifth line data signal output based on the fifth line data L5DATA, and the seventh line data signal output based on the seventh line data L7DATA may have a first polarity, and each of the second line data signal output based on the second line data L2DATA, the fourth line data signal output based on the fourth line data L4DATA, and the sixth line data signal output based on the sixth line data L6DATA may have a second polarity different from the first polarity. The first polarity may be a positive polarity and the second polarity may be a negative polarity. Alternatively, the first polarity may be a negative polarity and the second polarity may be a positive polarity.

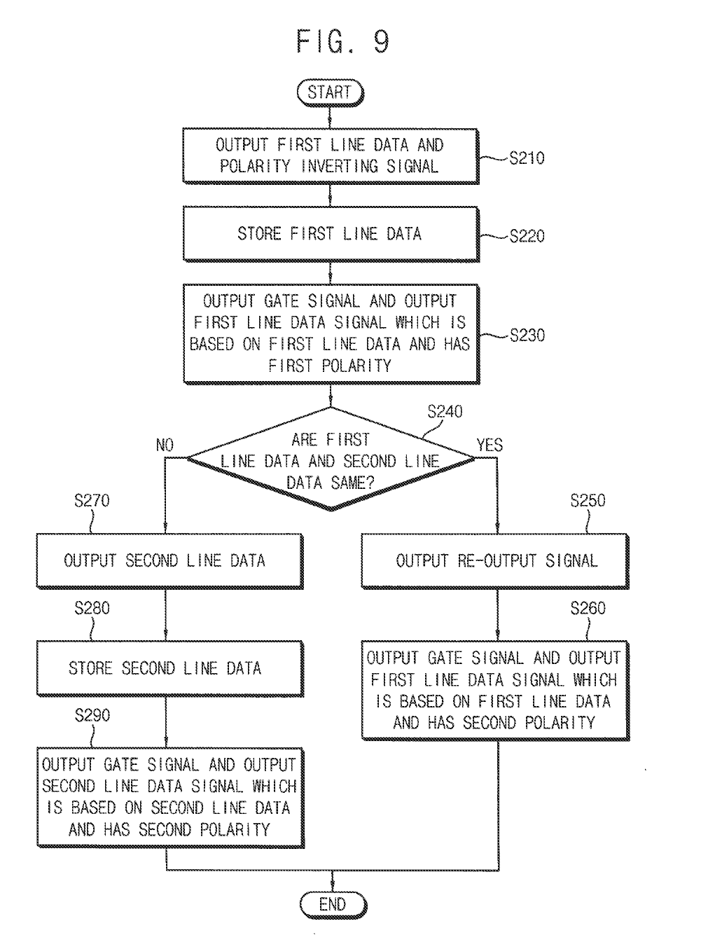

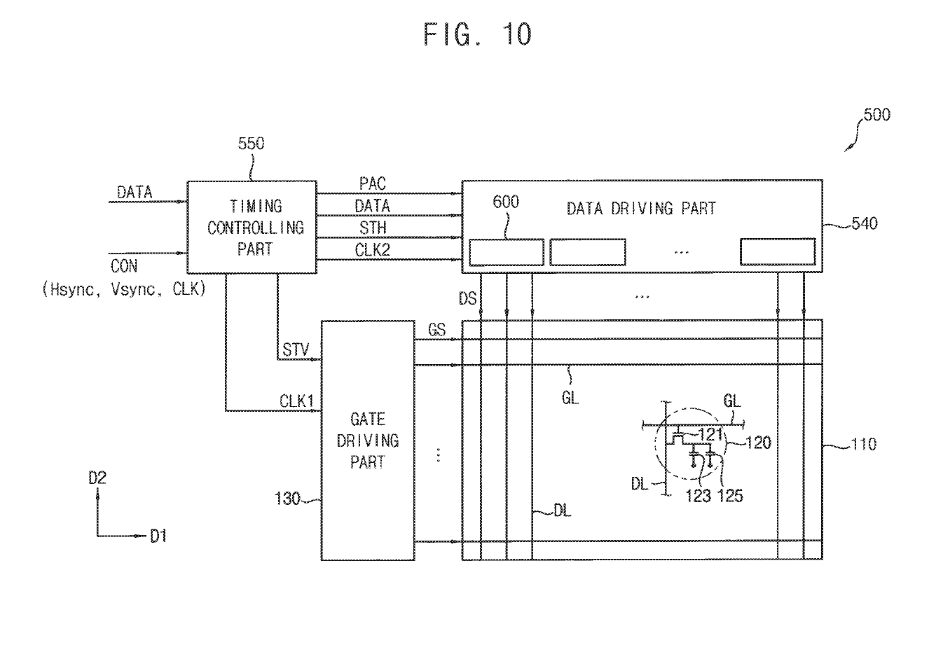

FIG. 9 is a flow chart illustrating a method of driving a display panel performed by the display panel driving apparatus of FIG. 6.

Referring to FIGS. 6 to 8, the first line data and the polarity inverting signal POL are output (step S210). Specifically, the timing controlling part 350 outputs the first line data displayed on the first line of the display panel 110 to the data driving part 340. The timing controlling part 350 outputs the polarity inverting signal POL for inverting the polarities of the data signals in the line unit to the data driving unit 340.

The first line data is stored (step S220). Specifically, the data driving part 340 stores the first line data provided from the timing controlling part 350. For example, the data driving part 340 may store the first line data in the latch 230.

The gate signal GS is output and the first line data signal, which is based on the first line data and has the first polarity, is output (step S230). Specifically, the gate driving part 130 outputs the gate signal GS to the gate line GL. The data driving part 340 outputs the first line data signal, which is based on the first line data and has the first polarity, according to the polarity inverting signal POL to the data line corresponding to the first line.

The first line data is compared with the second line data to be determined if the first line data and the second line data are the same (step S240). Specifically, the timing controlling part 350 compares the first line data with the second line data displayed on the second line of the display panel 110.

When the first line data and the second line data are the same, the re-output signal ROS is output (step S250). Specifically, the timing controlling part 350 outputs, to the data driving part 340, the re-output signal ROS, which instructs the output of the first line data signal based on the first line data to the data line corresponding to the second line. In this case, the timing controlling part 350 may not output the second line data to the data driving part 340.

The gate signal GS is output and the first line data signal which is based on the first line data and has the second polarity is output (step S260). Specifically, the gate driving part 130 outputs the gate signal GS to the gate line GL. The data driving part 340 outputs the first line data signal, which is based on the first line data and has the second polarity according to the polarity inverting signal POL, to the data line corresponding to the second line.

Referring back to step S240, when the first line data and the second line data are different, the second line data is output (step S270). Specifically, the timing controlling part 350 outputs the second line data displayed on the second line of the display panel 110 to the data driving part 340.

The second line data is stored (step S280). Specifically, the data driving part 340 stores the second line data provided from the timing controlling part 350. For example, the data driving part 340 may store the second line data in the latch 230.

The gate signal GS is output and the second line data signal which is based on the second line data and has the second polarity is output (step S290). Specifically, the gate driving part 130 outputs the gate signal GS to the gate line GL. The data driving part 340 outputs the second line data signal which is based on the second line data and has the second polarity according to the polarity inverting signal POL to the data line corresponding to the second line.

According to the present exemplary embodiment, since the second line data is not output from the timing controlling part 350 to the data driving part 340 when the first line data and the second line data are the same, an amount of data communication between the data driving part 340 and the timing controlling part 350 may be decreased. Thus, power consumption of the display apparatus 300 may be decreased and an electromagnetic interference (EMI) due to data communication may be decreased.

Since the polarities of the data signals DS are inverted in the line unit, a degradation of the display panel 110 may be prevented.

FIG. 10 is a block diagram illustrating a display apparatus according to an exemplary embodiment of the present inventive concept.

The display apparatus 500 according to the present exemplary embodiment is substantially the same as the display apparatus 100 according to the exemplary embodiment illustrated in FIG. 1 except for a data driving part 540 and a timing controlling part 550. Thus, the same reference numerals may be used to refer to same or like parts as those described in the previous exemplary embodiment and any further repetitive explanation concerning the above elements may be omitted.

Referring to FIG. 10, the display apparatus 500 according to the present exemplary embodiment includes the display panel 110, the gate driving part 130, the data driving part 540, and the timing controlling part 550.

The gate driving part 130, the data driving part 540, and the timing controlling part 550 may be collectively defined as a display panel driving apparatus driving the display panel 110.

The data driving part 540 outputs the data signal DS to the data line DL in response to the data start signal STH and the data clock signal CLK2 provided from the timing controlling part 550. The data driving part 540 may include a plurality of data driving circuit parts 600 which receive the image data DATA and output the data signal DS.

The data driving part 540 stores the first line data displayed on the first line of the display panel 110, among the image data DATA, and outputs the first line data signal based on the first line data to the data line corresponding to the first line. When the first line data and the second line data displayed on the second line next to the first line of the display panel 110 are the same, the data driving part 540 may output the first line data signal based on the first line data to the data line corresponding to the second line in response to packet data PAC provided from the timing controlling part 550. Here, the first line may correspond to the first gate line among the gate lines GL and the second line may correspond to the second gate line next to the first gate line.

The data driving part 540 may invert the polarities of the first line data signal and the second line data signal in the line unit of the first line and the second line according to the packet data PAC provided from the timing controlling part 550. Specifically, the data driving part 540 may invert polarities of the data signals DS for every line according to the packet data PAC.

The timing controlling part 550 receives the image data DATA and the control signal CON from an external source. The control signal CON may include the horizontal synchronous signal Hsync, the vertical synchronous signal Vsync and the clock signal CLK. The timing controlling part 550 generates the data start signal STH using the horizontal synchronous signal Hsync and outputs the data start signal STH to the data driving part 540. The timing controlling part 550 generates the gate start signal STV using the vertical synchronous signal Vsync and outputs the gate start signal STV to the gate driving part 130. The timing controlling part 550 generates the gate clock signal CLK1 and the data clock signal CLK2 using the clock signal CLK, outputs the gate clock signal CLK1 to the gate driving part 130, and outputs the data clock signal CLK2 to the data driving part 540.

The timing controlling part 550 compares the first line data with the second lime data among the image data DATA, and outputs the packet data PAC which indicates if the first line data and the second line data are the same to the data driving part 540.

When the packet data PAC indicates that the first line data and the second line data are the same, the packet data PAC may include a signal like that of the re-output signal RO S according to the exemplary embodiment illustrated in FIG. 1. Thus, when the first line data and the second line data are the same, the packet data PAC may instruct the output of the first line data signal based on the first line data to the data line corresponding to the second line. In this case, the timing controlling part 550 may not output the second line data to the data driving part 540.

When the packet data PAC indicates that the first line data and the second line data are different, the timing controlling part 550 outputs the second line data to the data driving part 540. In this case, the data driving part 540 stores the second line data, and outputs a second line data signal based on the second line data to the data line corresponding to the second line.

The packet data PAC may designate polarities of the first line data signal based on the first line data and the second line data signal based on the second line data. The polarities of the first line data signal and the second line data signal may be inverted in the line unit for the first line and the second line.

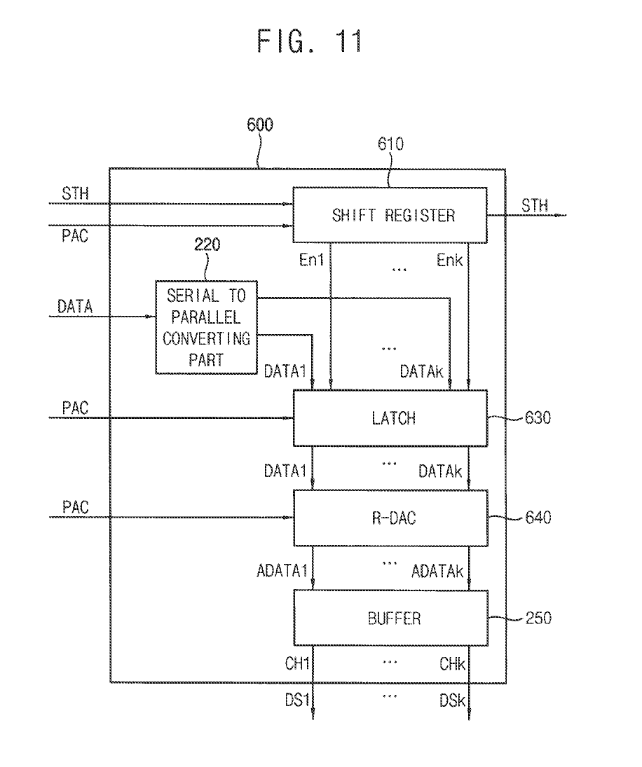

FIG. 11 is a block diagram illustrating the data driving circuit part 600 in the data driving part 540 of FIG. 10.

The data driving circuit part 600 according to the present exemplary embodiment is substantially the same as the data driving circuit part 200 according to the exemplary embodiment illustrated in FIG. 2 except for a shift register 610, a latch 630, and a digital to analog converting part 640. Thus, the same reference numerals may be used to refer to same or like parts as those described in the previous exemplary embodiment and any further repetitive explanations may be omitted.

Referring to FIGS. 10 and 11, the data driving circuit part 600 includes the shift register 610, the serial to parallel converting part 220, the latch 630, the digital to analog converting part 640, and the buffer 250.

The shift register 610 provides the parallel data DATA1, . . . , and DATAk to the latch 630 while the shift register 610 shifts the data start signal STH. When the packet data PAC from the timing controlling part 550 indicates that the first line data and the second line data are the same, the shift register 610 may not output the enable signals En1, . . . , and Enk and may not store the parallel data DATA1, . . . , and DATAk in the latch 630.

The latch 630 stores the parallel data DATA1, . . . , and DATAk and outputs the parallel data DATA1, . . . , and DATAk to the digital to analog converting part 640. Here, when the parallel data DATA1, . . . , and DATAk are displayed on the first line of the display panel 110, the parallel data DATA1, . . . , and DATAk may be the first line data. When the parallel data DATA1, . . . , and DATAk are displayed on the second line of the display panel 110, the parallel data DATA1, . . . , and DATAk may be the second line data. Thus, the latch 630 may store the first line data and the second line data. The latch 630 may include a first storage part storing the first line data, and a second storage part storing the second line data. Thus, the latch 630 may store the second line data in the second storage part while the latch 630 outputs the first line data from the first storage part. In this case, although the first line data is output from the first storage part of the latch 630, the latch 630 may store the first line data.

When the timing controlling part 550 determines that the first line data and the second line data are the same and thus the latch 630 receives the packet data PAC which indicates that the first line data and the second line data are the same from the timing controlling part 550, the latch 630 may not receive the second line data from the timing controlling part 550 and output the stored first line data.

The digital to analog converting part 640 receives the parallel data DATA1, . . . , and DATAk from the latch 630, converts the parallel data DATA1, . . . , and DATAk into the analog data ADATA1, . . . , and ADATAk, and outputs the analog data ADATA1, . . . , and ADATAk to the buffer 250. In this case, the digital to analog converting part 640 inverts the polarities of the analog data ADATA1, . . . , and ADATAk in the line unit according to the packet data PAC provided from the timing controlling part 550. Thus, the polarities of the data signals DS output from the data driving part 540 may be inverted in the line unit. The digital to analog converting part 640 may be a resistor digital to analog converting (R-DAC) part including resistors.

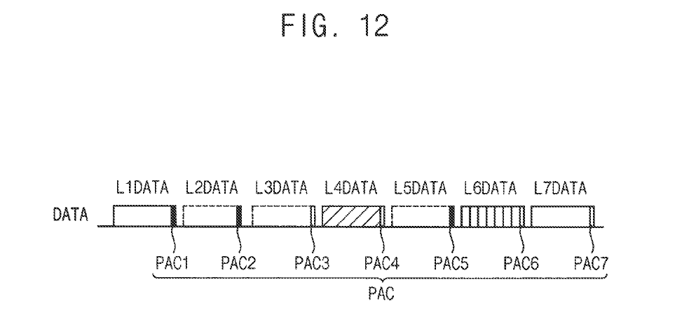

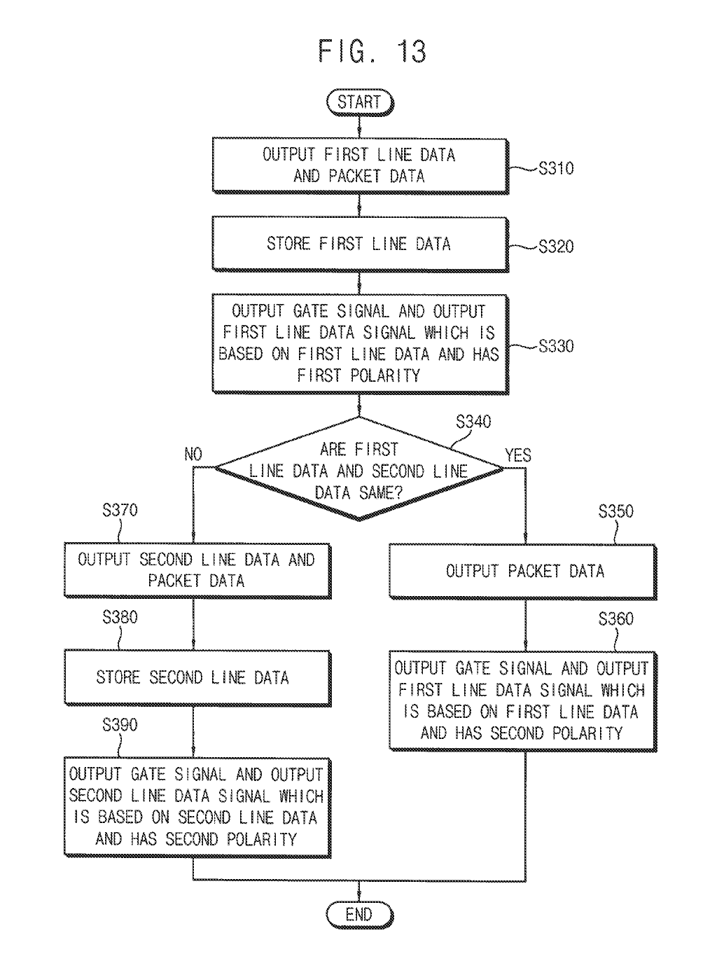

FIG. 12 is a timing diagram illustrating the image data DATA and the packet data PAC output from the timing controlling part 550 to the data driving part 540 of FIG. 10.

Referring to FIGS. 10 to 12, the image data DATA may be displayed on the display panel 110 as described in FIG. 3. Thus, the image data DATA may include the first line data L1DATA displayed on the first line L1 of the display panel 110, the second line data L2DATA displayed on the second line L2 of the display panel 110, the third line data L3DATA displayed on the third line L3 of the display panel 110, the fourth line data L4DATA displayed on the fourth line L4 of the display panel 110, the fifth line data L5DATA displayed on the fifth line L5 of the display panel 110, the sixth line data L6DATA displayed on the sixth line L6 of the display panel 110, and the seventh line data L7DATA displayed on the seventh line L7 of the display panel 110. For example, the first line data L1DATA, the second line data L2DATA and the third line data L3DATA may be the same. The third line data L3DATA and the fourth line data L4DATA may be different. The fourth line data L4DATA and the fifth line data L5DATA may be the same. The fifth line data L5DATA and the sixth line data L6DATA may be different. The sixth line data L6DATA and the seventh line data L7DATA may be different.

A first packet data PAC1 among the packet data PAC may indicate that the first line data L1DATA and the second line data L2DATA are the same. The first packet data PAC1 may designate the polarity of the first line data signal output based on the first line data L1DATA as a first polarity.

A second packet data PAC2 among the packet data PAC may indicate that the second line data L2DATA and the third line data L3DATA are the same. The second packet data PAC2 may designate the polarity of the first line data signal output based on the first line data L1DATA being the same as the second line data L2DATA and a second polarity being different from the first polarity.

A third packet data PAC3 among the packet data PAC may indicate that the third line data L3DATA and the fourth line data L4DATA are different. The third packet data PAC3 may designate the polarity of the first line data signal output based on the first line data L1DATA the same as the third line data L3DATA as the first polarity.

A fourth packet data PAC4 among the packet data PAC may indicate that the fourth line data L4DATA and the fifth line data L5DATA are the same. The fourth packet data PAC4 may designate the polarity of the fourth line data signal output based on the fourth line data L4DATA as the second polarity.

A fifth packet data PAC5 among the packet data PAC may indicate that the fifth line data L5DATA and the sixth line data L6DATA are different. The fifth packet data PAC5 may designate the polarity of the fourth line data signal output based on the fourth line data L4DATA the same as the fifth line data L5DATA as the first polarity.

A sixth packet data PAC6 among the packet data PAC may indicate that the sixth line data L6DATA and the seventh line data L7DATA are different. The sixth packet data PAC6 may designate the polarity of the sixth line data signal output based on the sixth line data L6DATA as the second polarity.

The seventh packet data PACT among the packet data PAC may designate the polarity of the seventh line data signal output based on the seventh line data L7DATA as the first polarity.

Since the first line data L1DATA, the second line data L2DATA and the third line data L3DATA are the same, the second line data L2DATA and the third line data L3DATA which are the same as a previous line data may not output from the timing controlling part 550 to the data driving part 540. In this case, the data driving part 540 may output the first line data signal based on the first line data L1DATA to the data line corresponding to the second line L2 and the data line corresponding to the third line L3.

Since the fourth line data L4DATA and the fifth line data L5DATA are the same, the fifth line data L5DATA which is the same as a previous line data may not be output from the timing controlling part 550 to the data driving part 540. In this case, the data driving part 540 may output the fourth line data signal based on the fourth line data L4DATA to the data line corresponding to the fifth line L5.

FIG. 13 is a flow chart illustrating a method of driving a display panel performed by the display panel driving apparatus of FIG. 10.

Referring to FIGS. 10 to 13, the first line data and the packet data PAC are output (step S310). Specifically, the timing controlling part 550 outputs the first line data displayed on the first line of the display panel 110 to the data driving part 540. The timing controlling part 550 outputs the packet data PAC indicating whether the first line data and the second line data displayed on the second line of the display panel 110 are the same or not and designating the polarity of the first line data signal to the data driving part 540.

The first line data is stored (step S320). Specifically, the data driving part 540 stores the first line data provided from the timing controlling part 550. For example, the data driving part 540 may store the first line data in the latch 630.

The gate signal GS is output and the first line data signal, which is based on the first line data and has the first polarity, is output (step S330). Specifically, the gate driving part 130 outputs the gate signal GS to the gate line GL. The data driving part 540 outputs the first line data signal, which is based on the first line data and has the first polarity according to the packet data PAC to the data line corresponding to the first line.

The first line data is compared with the second line data to be determined that the first line data and the second line data are the same (step S340). Specifically, the timing controlling part 550 compares the first line data with the second line data displayed on the second line of the display panel 110.

When the first line data and the second line data are the same, the packet data PAC is output (step S350). Specifically, the timing controlling part 550 outputs, to the data driving part 540, the packet data PAC, which indicates that the first line data and the second line data are the same, instructs the output of the first line data signal based on the first line data to the data line corresponding to the second line, and designates the polarity of the first line data signal output to the data line corresponding to the second line. In this case, the timing controlling part 550 may not output the second line data to the data driving part 540.

The gate signal GS is output and the first line data signal which is based on the first line data and has the second polarity is output (step S360). Specifically, the gate driving part 130 outputs the gate signal GS to the gate line GL. The data driving part 540 outputs the first line data signal which is based on the first line data and has the second polarity according to the packet data PAC to the data line corresponding to the second line.

When the first line data and the second line data are different, the second line data is output (step S370). Specifically, the timing controlling part 550 outputs the second line data displayed on the second line of the display panel 110 to the data driving part 540.

The second line data is stored (step S380). Specifically, the data driving part 540 stores the second line data provided from the timing controlling part 550. For example, the data driving part 540 may store the second line data in the latch 630.

The gate signal GS is output and the second line data signal, which is based on the second line data and has the second polarity, is output (step S390). Specifically, the gate driving part 130 outputs the gate signal GS to the gate line GL. The data driving part 540 outputs the second line data signal which is based on the second line data and has the second polarity according to the packet data PAC to the data line corresponding to the second line.

In exemplary embodiments, the gate driving part 130, the data driving part 140/340/540, the timing controlling part 150/350/550, and/or one or more components thereof, may be implemented via one or more general purpose and/or special purpose components, such as one or more discrete circuits, digital signal processing chips, integrated circuits, application specific integrated circuits, microprocessors, processors, programmable arrays, field programmable arrays, instruction set processors, and/or the like.

According to exemplary embodiments, the features, functions, processes, etc., described herein may be implemented via software, hardware (e.g., general processor, digital signal processing (DSP) chip, an application specific integrated circuit (ASIC), field programmable gate arrays (FPGAs), etc.), firmware, or a combination thereof. In this manner, the gate driving part 130, the data driving part 140/340/540, the timing controlling part 150/350/550, and/or one or more components thereof may include or otherwise be associated with one or more memories (not shown) including code (e.g., instructions) configured to cause the gate driving part 130, the data driving part 140/340/540, the timing controlling part 150/350/550, and/or one or more components thereof to perform one or more of the features, functions, processes, etc., described herein.

The memories may be any medium that participates in providing code to the one or more software, hardware, and/or firmware components for execution. Such memories may be implemented in any suitable form, including, but not limited to, non-volatile media, volatile media, and transmission media. Non-volatile media include, for example, optical or magnetic disks. Volatile media include dynamic memory. Transmission media include coaxial cables, copper wire and fiber optics. Transmission media can also take the form of acoustic, optical, or electromagnetic waves. Common forms of computer-readable media include, for example, a floppy disk, a flexible disk, hard disk, magnetic tape, any other magnetic medium, a compact disk-read only memory (CD-ROM), a rewriteable compact disk (CDRW), a digital video disk (DVD), a rewriteable DVD (DVD-RW), any other optical medium, punch cards, paper tape, optical mark sheets, any other physical medium with patterns of holes or other optically recognizable indicia, a random-access memory (RAM), a programmable read only memory (PROM), and erasable programmable read only memory (EPROM), a FLASH-EPROM, any other memory chip or cartridge, a carrier wave, or any other medium from which information may be read by, for example, a controller/processor.

According to the present exemplary embodiment, since the second line data is not output from the timing controlling part 550 to the data driving part 540 when the first line data and the second line data are the same, an amount of data communication between the data driving part 540 and the timing controlling part 550 may be decreased. Thus, power consumption of the display apparatus 500 may be decreased and an electromagnetic interference (EMI) due to a data communication may be decreased.

Since the polarities of the data signals DS are inverted in the line unit, a degradation of the display panel 110 may be prevented.

According to the method of driving a display panel, the display panel driving apparatus for performing the method and the display apparatus having the display panel driving apparatus, an amount of data communication between a data driving part and a timing controlling part may be decreased. Thus, power consumption of a display apparatus may be decreased and an electromagnetic interference (EMI) due to a data communication may be decreased.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A method of driving a display panel, the method comprising:
outputting a first line data comprising image data to be displayed on a display panel, the display panel comprising a gate line and a data line;
outputting a gate signal to the gate line and outputting a first line data signal based on the first line data to a data line corresponding to a first line;
determining if the first line data and a second line data are the same; and
outputting the gate signal to the gate line and outputting the first line data signal based on the first line data to a data line corresponding to a second line next to the first line, when the first line data and the second line data are the same.

2. The method of claim 1, further comprising:
outputting a re-output signal, the re-output signal controlling the outputting of the first line data signal to the data line corresponding to the second line, when the first line data and the second line data are the same.

3. The method of claim 1, further comprising:
storing the first line data.

4. The method of claim 1, further comprising:
outputting a polarity inverting signal, the polarity inverting signal configured to invert a polarity of the first line data signal in a line unit of the first line and the second line,
wherein the polarity of the first line data signal is inverted in the line unit according to the polarity inverting signal.

5. The method of claim 1, further comprising:
outputting a packet data that indicates whether the first line data and the second line data are the same.

6. The method of claim 5, wherein the packet data designates a polarity of the first line data signal.

7. The method of claim 6, wherein the polarity of the first line data signal is inverted in a line unit of the first line and the second line.

8. The method of claim 1, further comprising:
outputting the second line data when the first line data and the second line data are different; and
outputting the gate signal to the gate line and outputting a second line data signal based on the second line data to the data line corresponding to the second line.

9. The method of claim 8, further comprising:
outputting a polarity inverting signal, the polarity inverting signal controlling inversion of a polarity of the first line data signal and a polarity of the second line data signal in a line unit of the first line and the second line,
wherein the polarity of the first line data signal and the polarity of the second line data signal are inverted in the line unit according to the polarity inverting signal.

10. The method of claim 8, further comprising:
outputting a packet data, the packet data indicating whether the first line data and the second line data are the same.

11. The method of claim 10, wherein the packet data designates a polarity of the first line data signal and a polarity of the second line data signal.

12. The method of claim 11, wherein the polarity of the first line data signal and the polarity of the second line data signal are inverted in a line unit of the first line and the second line according to the packet data.

13. The method of claim 1, wherein the first line corresponds to the first gate line and the second line corresponds to the second gate line.

14. A display panel driving apparatus, comprising:
a timing controlling part configured to output a first line data of an image data to be displayed on a display panel comprising a gate line and a data line, and determine if the first line data and a second line data next to the first line data are the same;
a data driving part configured to output a first line data signal based on the first line data to a data line corresponding to a first line, and output the first line data signal based on the first line data to a data line corresponding to a second line next to the first line, when the first line data and the second line data are the same; and
a gate driving part configured to output a gate signal to the gate line.

15. The display panel driving apparatus of claim 14, wherein the timing controlling part is configured to output a re-output signal instructing the outputting of the first line data signal based on the first line data to the data line corresponding to the second line, when the first line data and the second line data are the same.

16. The display panel driving apparatus of claim 15, wherein the data driving part comprises a latch configured to store the first line data, and the data driving part is configured to output the first line data signal based on the first line data stored in the latch, in response to the re-output signal.

17. The display panel driving apparatus of claim 14, wherein the timing controlling part does not output the second line data to the data driving part when the first line data and the second line data are the same.

18. The display panel driving apparatus of claim 14, wherein the timing controlling part is configured to output the second line data to the data driving part, and the data driving part is configured to output a second line data signal based on the second line data to the data line corresponding to the second line, when the first line data and the second line data are different.

19. A display apparatus, comprising:
a display panel comprising a gate line and a data line; and
a display panel driving apparatus comprising:
a timing controlling part configured to output a first line data of an image data to be displayed on the display panel and determine whether the first line data and a second line data next to the first line data are the same,
a data driving part configured to output a first line data signal based on the first line data to a data line corresponding to a first line and output the first line data signal based on the first line data to a data line corresponding to a second line next to the first line when the first line data and the second line data are the same, and
a gate driving part configured to output a gate signal to the gate line.

20. The display apparatus of claim 19, wherein the timing controlling part is configured to output the second line data to the data driving part, and the data driving part is configured to output a second line data signal based on the second line data to the data line corresponding to the second line, when the first line data and the second line data are different.
